(19) United States
(12) Patent Application Publication
(10) Pub. No.: US 2014/0324224 A1
(43) Pub. Date: Oct. 30, 2014

(54) Integrated Human Machine Interface System and Method for Entryway Systems

(71) Applicant: BOON EDAM, INC., Lillington, NC (US)

(72) Inventors: Thomas Dolinshek, Clayton, NC (US); Joe Imhoff, Sanford, NC (US); Greg Kinney, Lillington, NC (US)

(73) Assignee: BOON EDAM, INC., Lillington, NC (US)

(21) Appl. No.: 14/211,388

(22) Filed: Mar. 14, 2014

Related U.S. Application Data
(60) Provisional application No. 61/784,064, filed on Mar. 14, 2013.

(51) Int. Cl. G05B 19/414

(52) U.S. Cl. CPC G05B 19/4147; G05B 2219/2628
USPC 700/275

(57) ABSTRACT

A HMI (human machine interface) system integrated into an entryway system is disclosed. The HMI (human machine interface) system integrated into an entryway system may include a one or more HMI units in electronic communication with a main controller of the entryway system.

### TECHNICAL FIELD

The invention is generally related to a human machine interface (HMI) system and method for entryway systems. More specifically, the invention is related to an HMI system and software integrated into an entryway system, for example, an automated revolving door system.

### BACKGROUND

In conventional entryway systems, such as automated revolving doors, a technician is typically required to physically remove a portion of the revolving door's ceiling and control box cover to access and manually make electrical adjustments and monitor the main controller, i.e., its programmable logic controller (PLC), of the automated revolving door system. To do this the technician is often required to climb a ladder or step stool and look vertically upward while monitoring and making electrical adjustments to the PLC. This presents a cumbersome, inefficient, and potentially unsafe process, as well as limiting potential functionality and enhancements (such as upgrades, etc.).

There is an increased demand for enhanced features to be integrated with these automated entryway systems, such as automated revolving doors, including enhanced interfacing for technicians, increased functionality in the areas of security, profile scheduling, remote notifications, and enhanced user interfacing.

It would be desirable to provide a system and software that is integrated into the automated entryway system, such as automated revolving doors, such that through an HMI, such as a touchscreen display, technicians could perform such tasks as monitoring sensor and device states, monitoring maintenance and error information, programming schedule profiles for various times and days of the week, making adjustments, updating/upgrading, sending pertinent information to the appropriate parties, electronically, such as via email, etc., all while at “eye level” with the HMI.

It would also be desirable to provide a system and software that provides for increased functionality in the areas of security profile scheduling, remote notifications, and enhanced user interfacing.

### SUMMARY

In one embodiment, an HMI (human machine interface) system integrated into an entryway system is provided. The HMI system may include one or more HMI units in electronic communication with a main controller of the entryway system. The one or more HMI units may be in electronic communication with one another. The main controller may include a programmable logic controller (PLC). The one or more HMI units may include at least two of a master HMI unit, a slave HMI unit, and/or a main HMI control unit. The master HMI unit and main HMI control unit may be capable of performing substantially the same functions. The one or more HMI units may include at least one of a pedestrian user interface and a technician user interface. The pedestrian user interface may include one or more of pedestrian access instructions and/or a status of a door of the entryway system. The technician user interface may include one or more of technician access instructions and/or menus for operation of the HMI system. The one or more HMI units may be positioned on an unsecure side of the entryway system and another of the one or more HMI units may be positioned on a secured side of the entryway system. The HMI unit positioned on the unsecure side of the entryway system may be a slave HMI unit and the other HMI unit positioned on the secured side of the entryway system may be at least one of a master HMI unit and/or a main HMI control unit. The master HMI unit may include at least a technician user interface and the slave HMI unit may include at least a pedestrian user interface. The entryway system may include a revolving door system. The one or more HMI units each may include a user interface. The user interface may include a touchscreen display. The HMI system may further include at least one of video and audio capability. One of the one or more HMI units may be positioned on an unsecure side of the entryway system and another of the one or more HMI units may be positioned at a centralized location, wherein the HMI unit positioned at the centralized location is in electronic communication with the one or more HMI units positioned on the unsecure side of the entryway system. The one or more HMI units may be capable of electronic communication with a remote user, device, and/or system via a communications link. The communications link preferably interfaces with the main controller of the entryway system. The main controller may include a programmable logic controller (PLC). The electronic communication may include email communication via an Ethernet module that interfaces with the PLC. The HMI system may further include menu driven software for operation of the HMI system. The operation of the HMI system may include one or more of operation, maintenance, programming, and monitoring of the entryway system. The HMI system may be programmed to execute the menu driven software for operation of the HMI system. The HMI system may further include a storage medium including program code embodied in the medium for executing the menu driven software for operation of the HMI system. The one or more HMI units and main controller may be coupled to a processor, and wherein the processor executes program code embodied in a storage medium for executing the menu driven software for operation of the HMI system.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1A illustrates an example unsecured side of an entryway system with the HMI system of the invention integrated therein;

FIG. 1B illustrates an example HMI unit of an unsecured side of an entryway system with the HMI system of the invention integrated therein;

FIG. 1C illustrates an example secured side of an entryway system with the HMI system of the invention integrated therein;

FIG. 1D illustrates an example HMI unit of a secured side of an entryway system with the HMI system of the invention integrated therein;

FIG. 2 illustrates a plurality of entryway system with the HMI system of the invention integrated therein connected to a centralized HMI unit;

FIGS. 3A-3I illustrate example Automatic Scheduling menu screens of the HMI system;

FIGS. 4A-4T illustrate example Device Status menu screens of the HMI system;

FIGS. 5A-5U illustrate example Maintenance menu screens of the HMI system;

FIGS. 6A-6B illustrate example Password Maintenance menu screens of the HMI system;

FIGS. 7A-7G illustrate example Network Setup menu screens of the HMI system;

FIGS. 8A-8G illustrate example Pedestrian User Interface screens of the HMI system;

FIGS. 9A-9H illustrate example Technician User Interface screens of the HMI system;

### DETAILED DESCRIPTION

The invention is generally related to a human machine interface (HMI) system and method for entryway systems. More specifically, the invention is related to a HMI system integrated into an entryway system, such as an automated revolving door system.

In accordance with one embodiment, the invention preferably includes an HMI system and supporting software integrated into an entryway system, for example, an automated revolving door system. The HMI system preferably includes one or more user interfaces, such as touchscreen displays. In one embodiment the system may include at least two (2) touchscreen displays, for example, a master that may serve as both a technician/programming interface and pedestrian user interface, and a slave which may serve primarily as a pedestrian user interface. The system may include electronic communication capability from the system to a remote user and/or system (remote computer, smartphone, tablet, pad, or other electronic device capable of electronic communication), via a communications link that interfaces with the main controller of the system, i.e., the system's programmable logic controller (PLC), for example the system may provide email communication or other electronic communication via a wired and/or wireless connection over a network.

The electronic communication capability (communications link) may be achieved via any suitable network for providing wired and/or wireless electronic communication. For example, the network may provide a connection to the Internet, e.g., via a local area network (LAN) or a wide area network (WAN). The communications link may be any wired and/or wireless communication interface for connecting to a network (not shown) and by which information may be exchanged with other devices connected to the network. Examples of wired communication interfaces may include, but are not limited to, USB ports, RS232 connectors, RJ45 connectors, Ethernet, and any combinations thereof. Examples of wireless communication interfaces may include, but are not limited to, an Intranet connection, Internet, ISM, Bluetooth® technology, Wi-Fi, Wi-Max, IEEE 402.11 technology, radio frequency (RF), Infrared Data Association (IrDA) compatible protocols, Local Area Networks (LAN), Wide Area Networks (WAN), Shared Wireless Access Protocol (SWAP), any combinations thereof, and other types of wireless networking protocols. In one example, the system may provide email communication or other electronic communication via an Ethernet module that interfaces with the PLC.

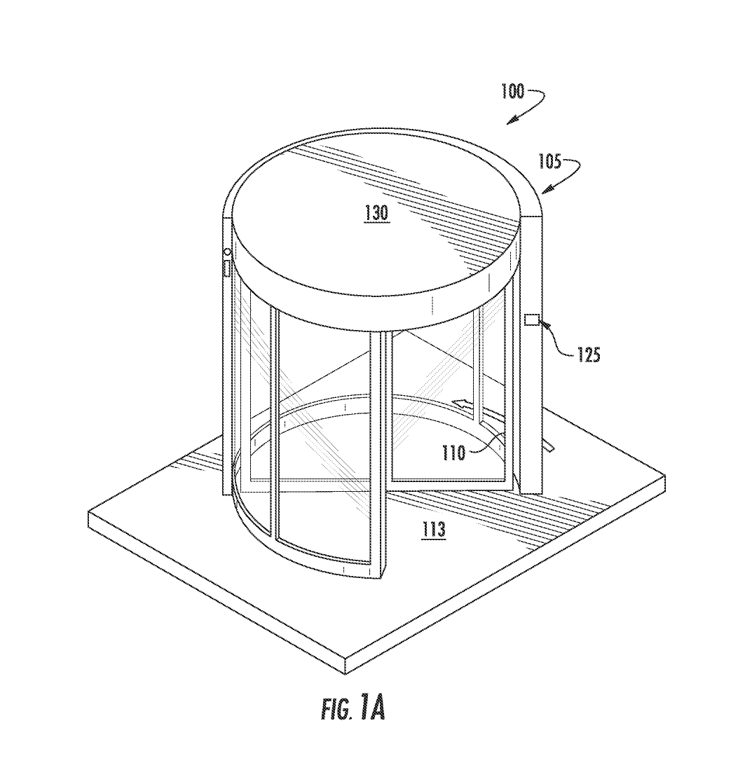

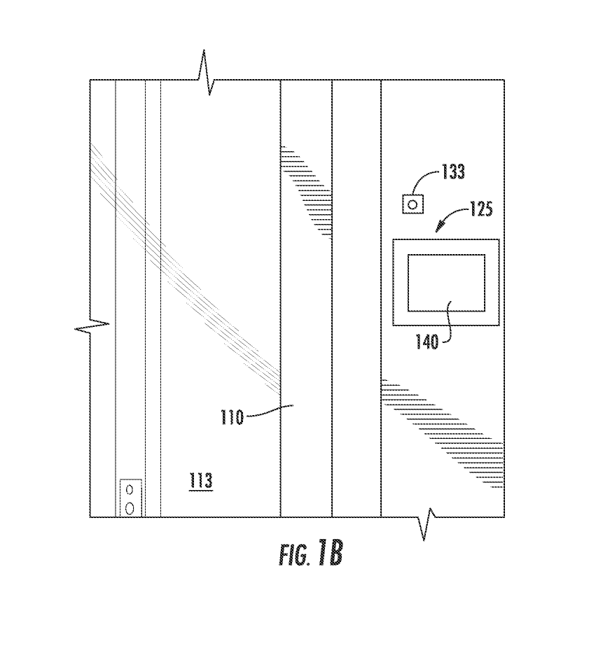

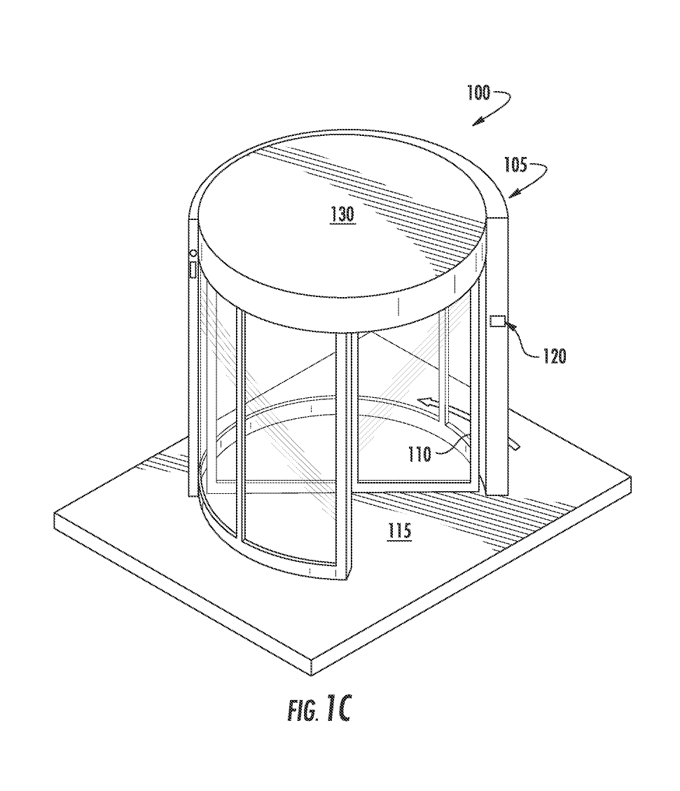

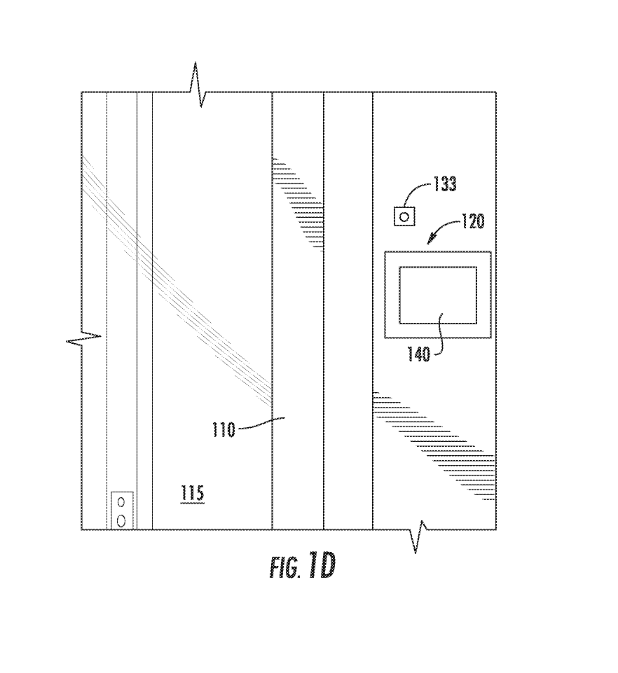

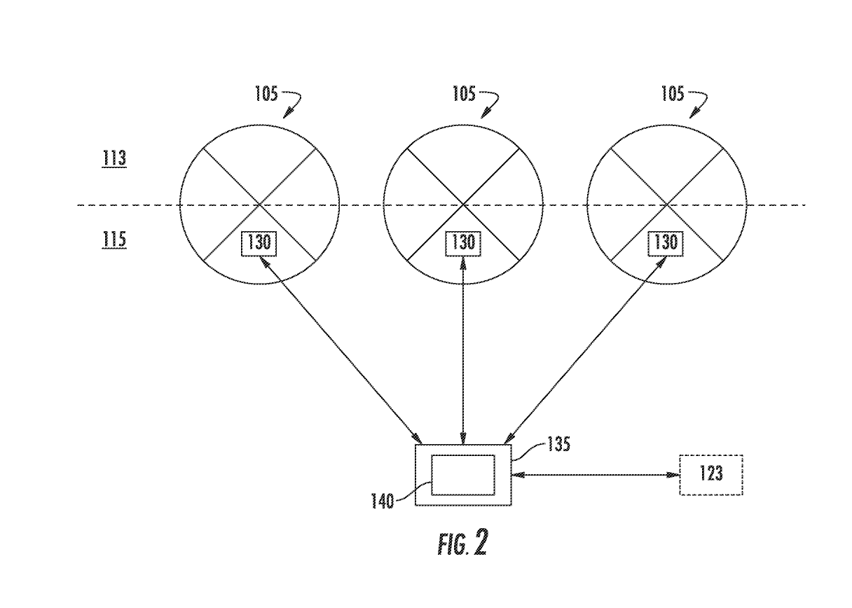

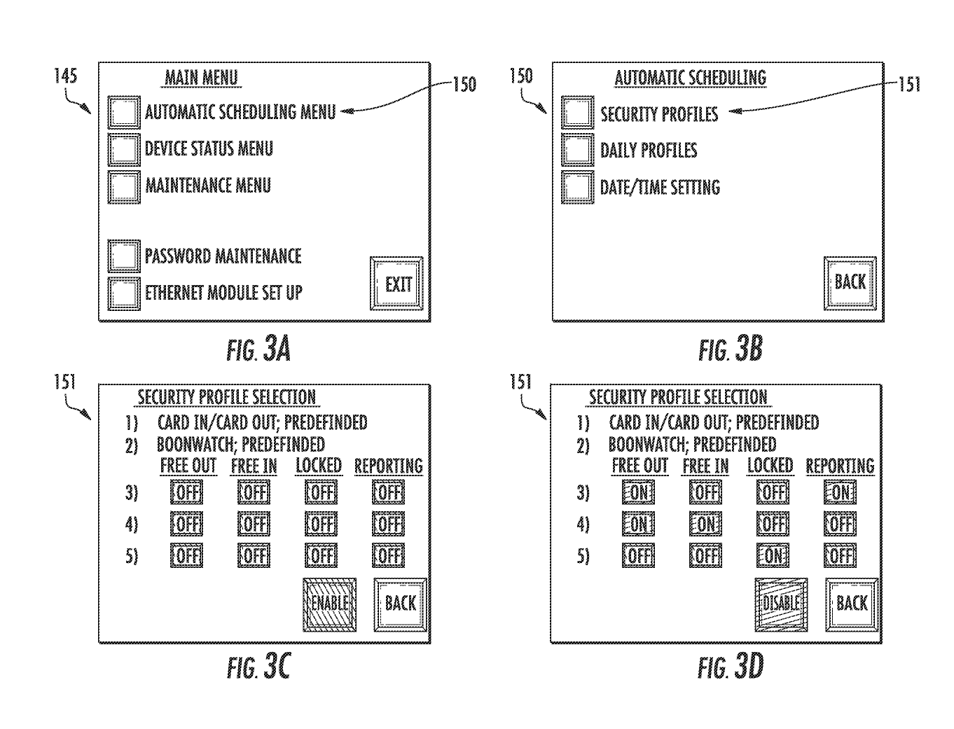

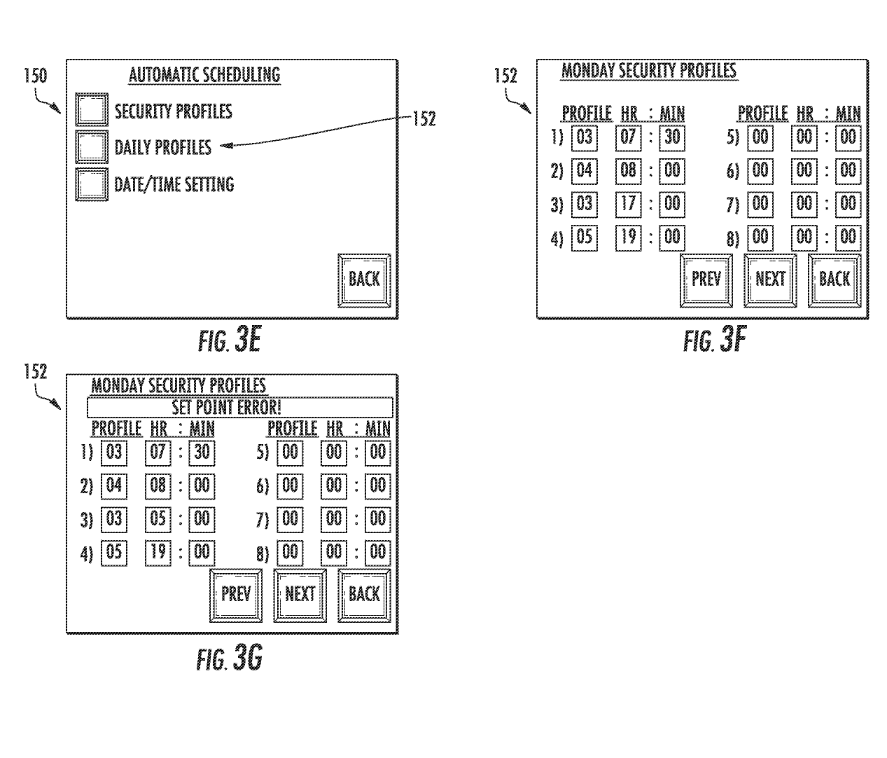

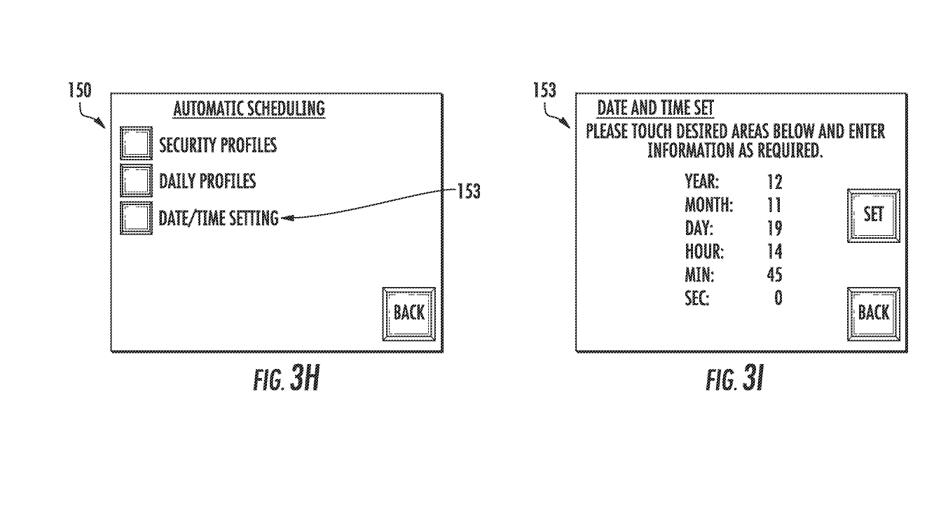

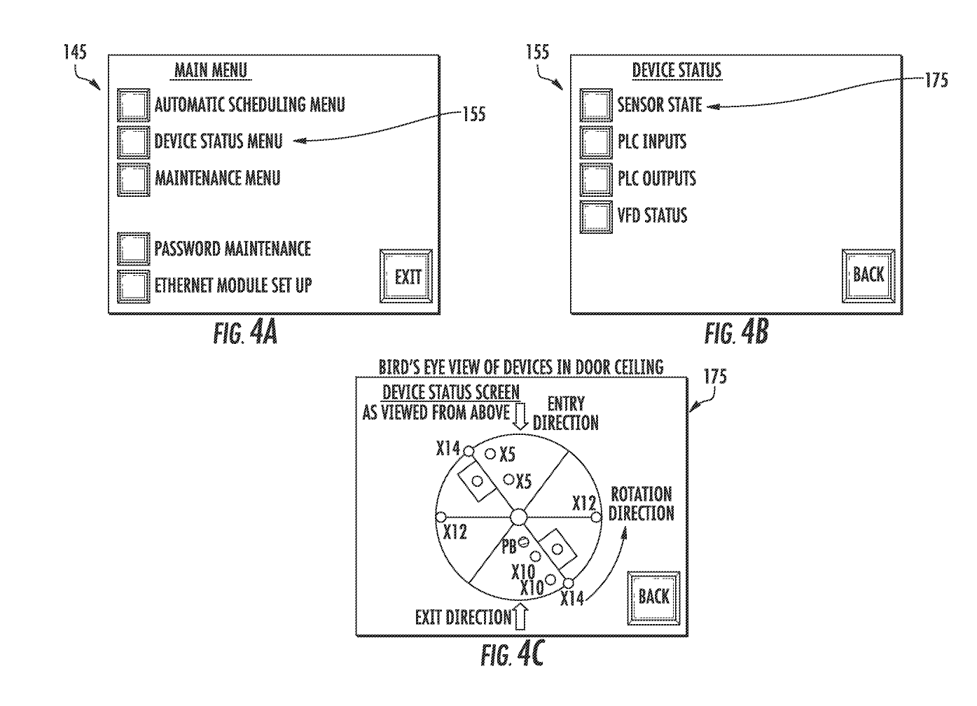

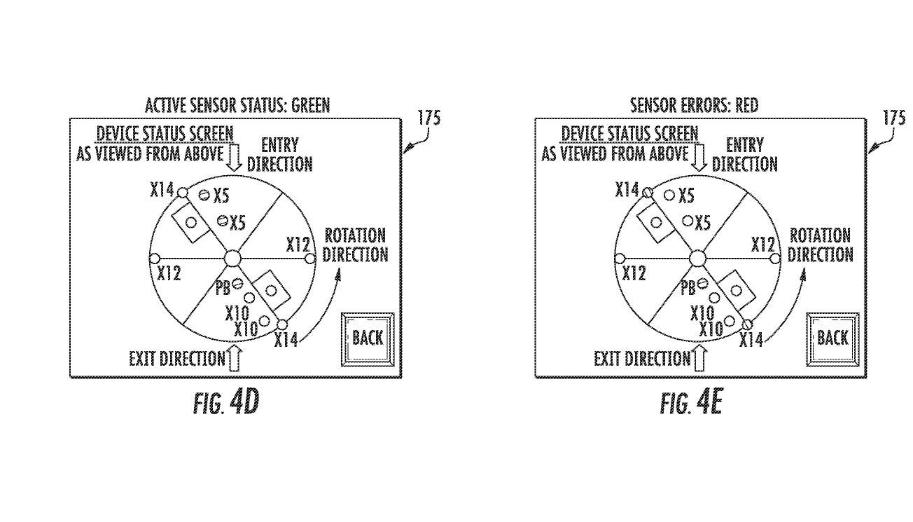

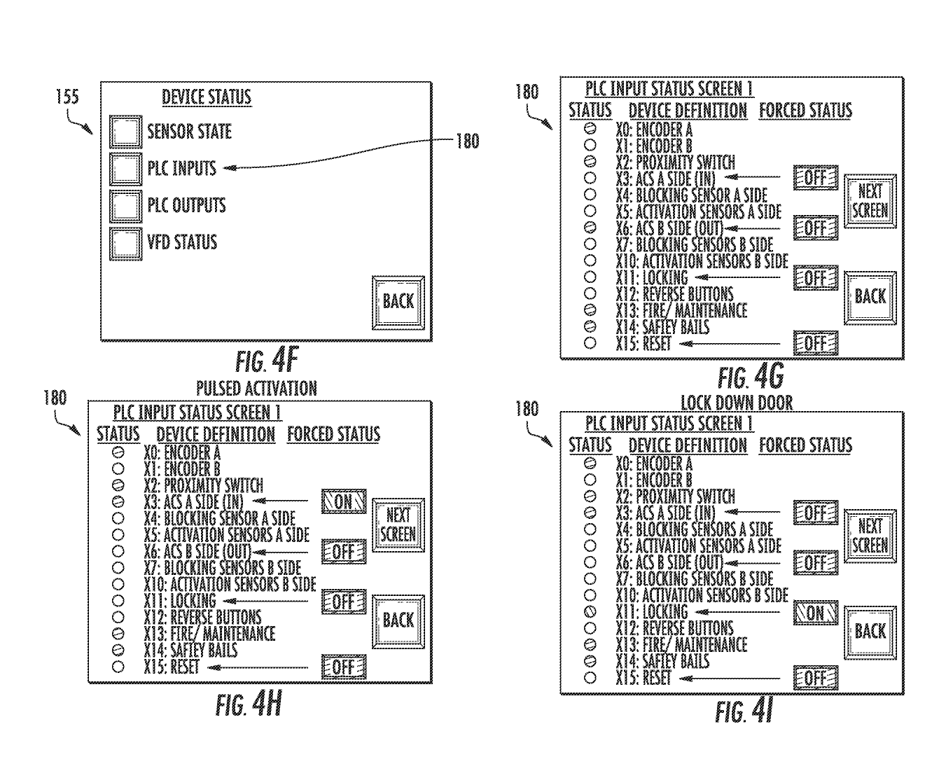

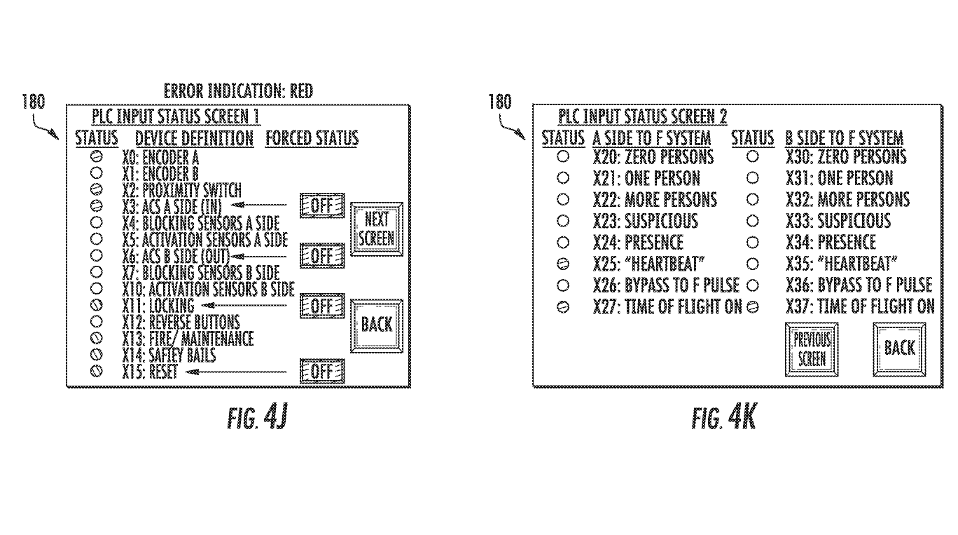

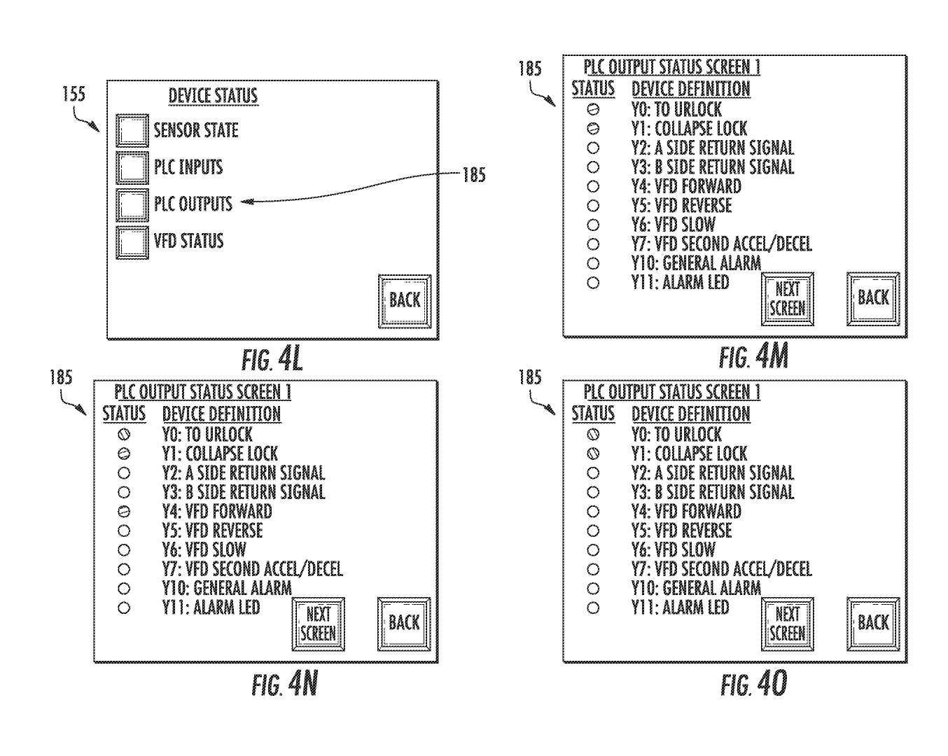

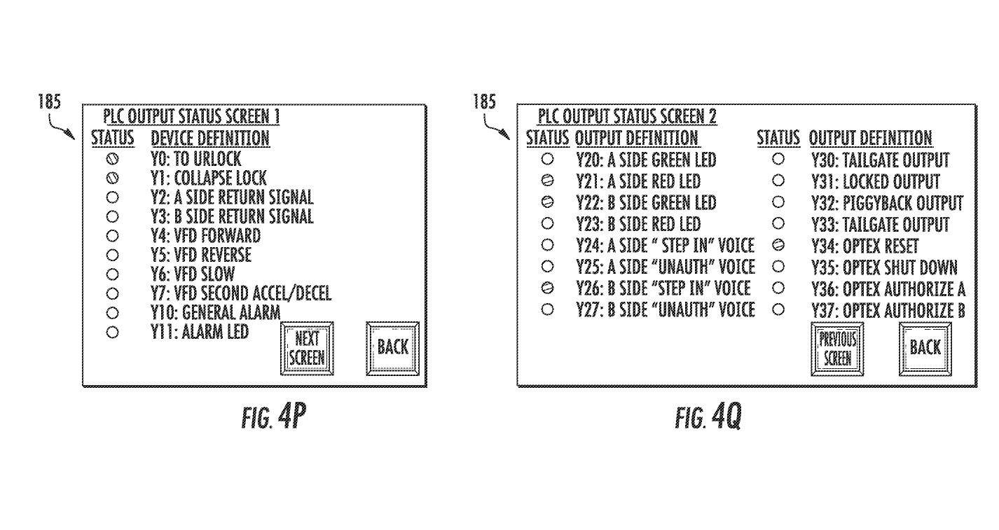

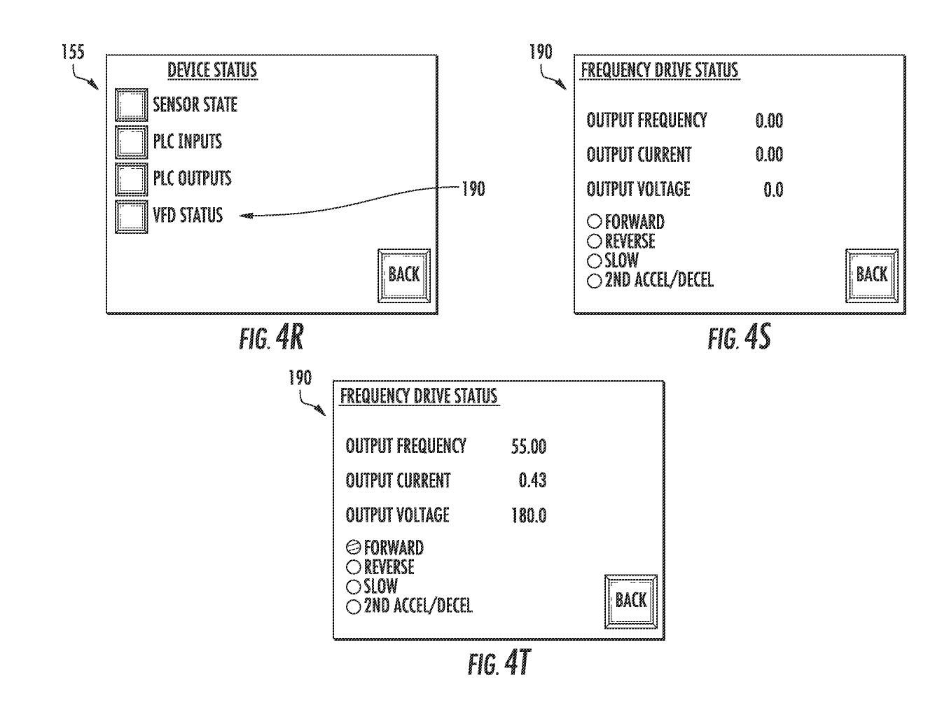

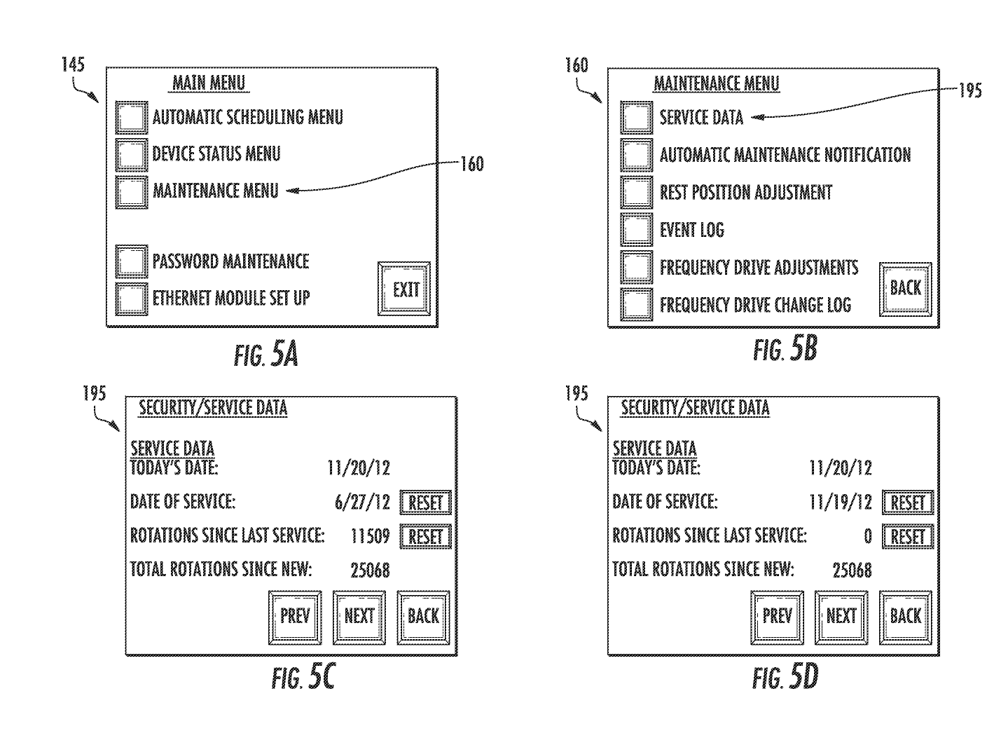

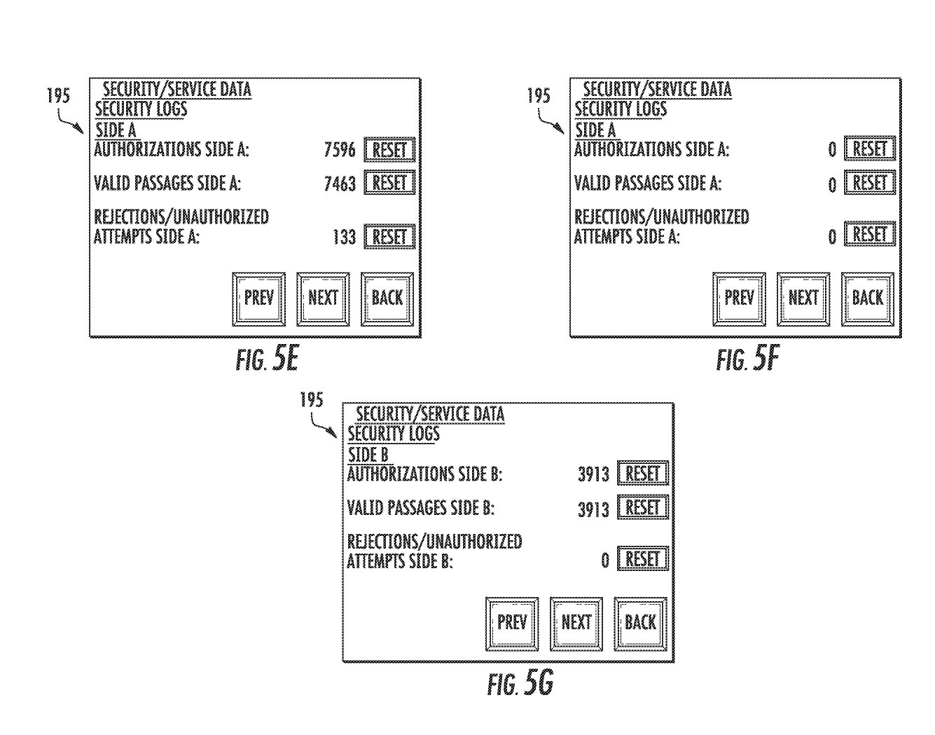

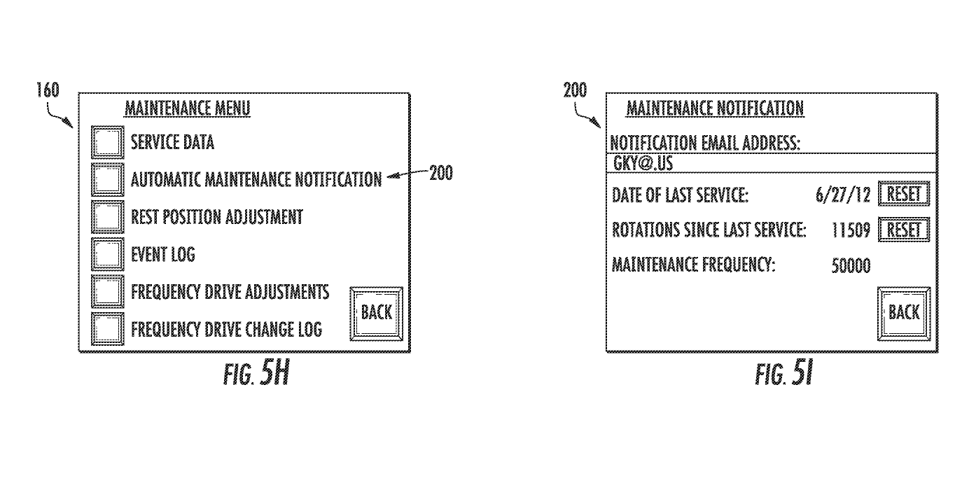

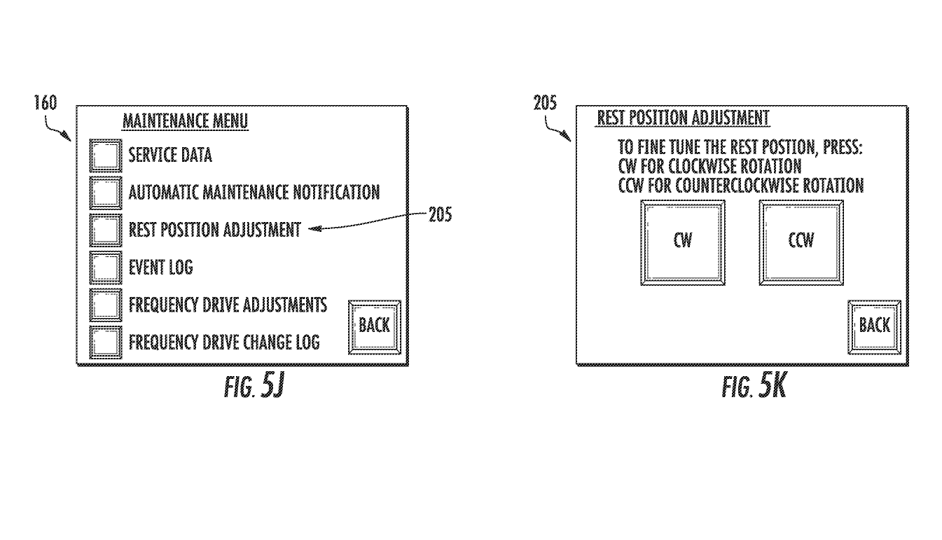

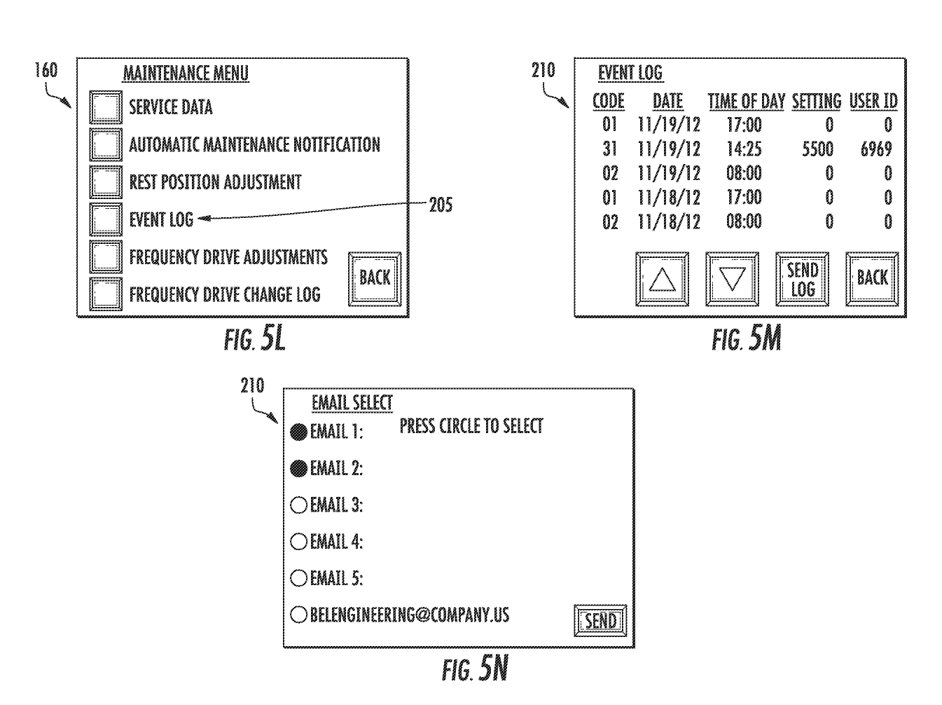

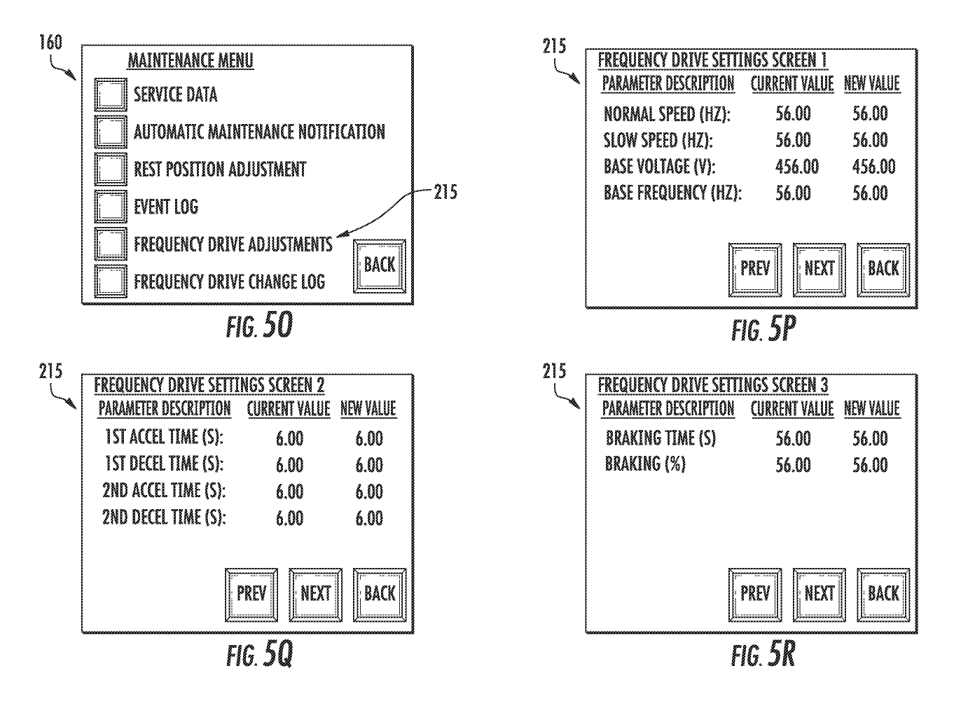

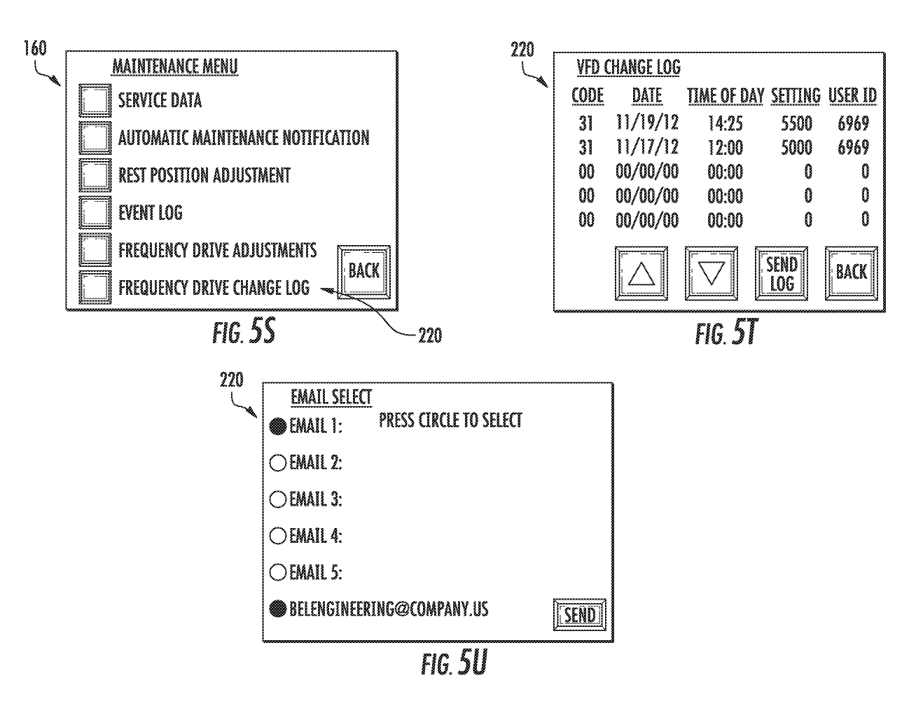

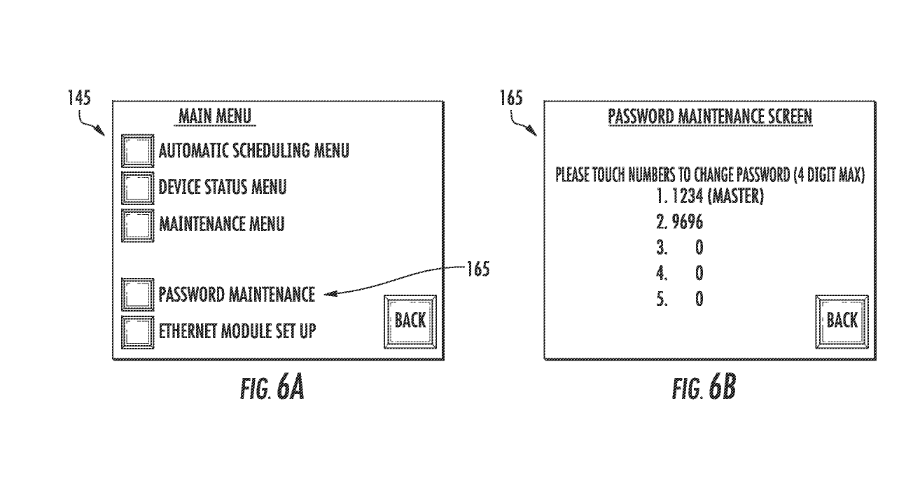

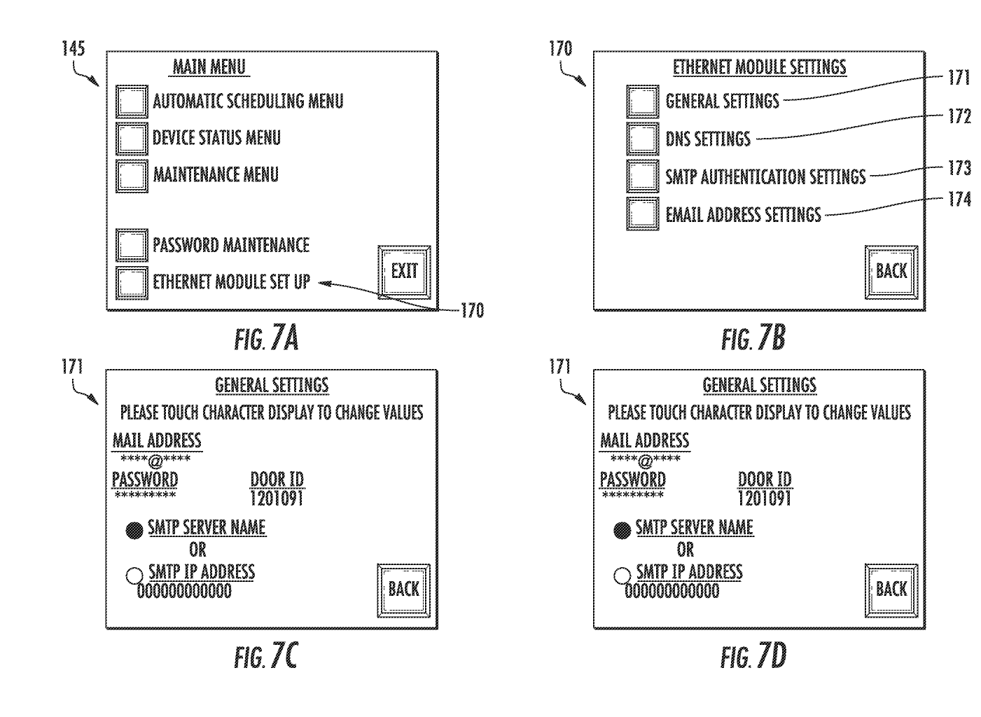

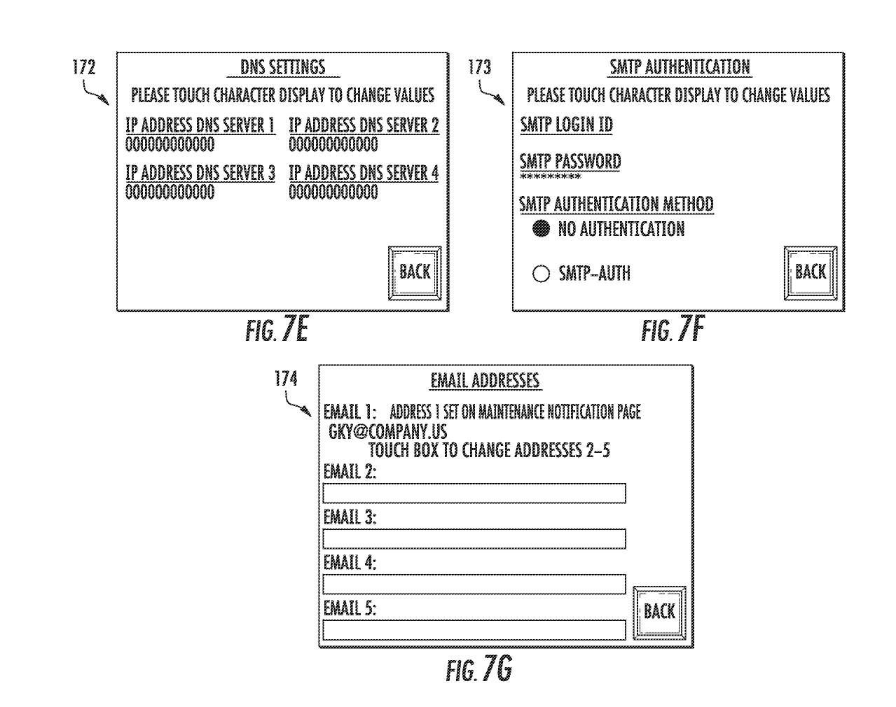

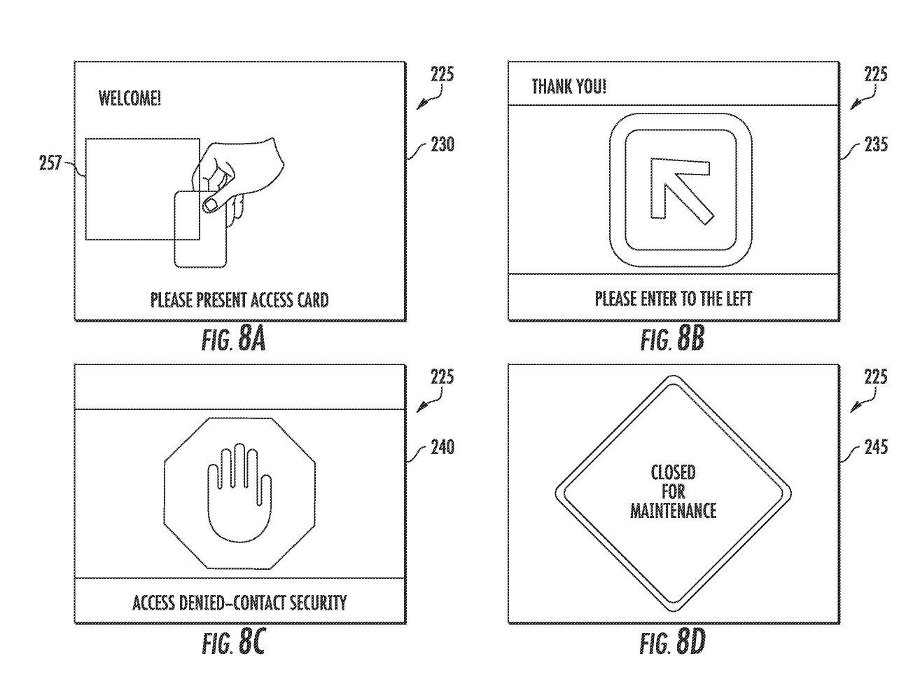

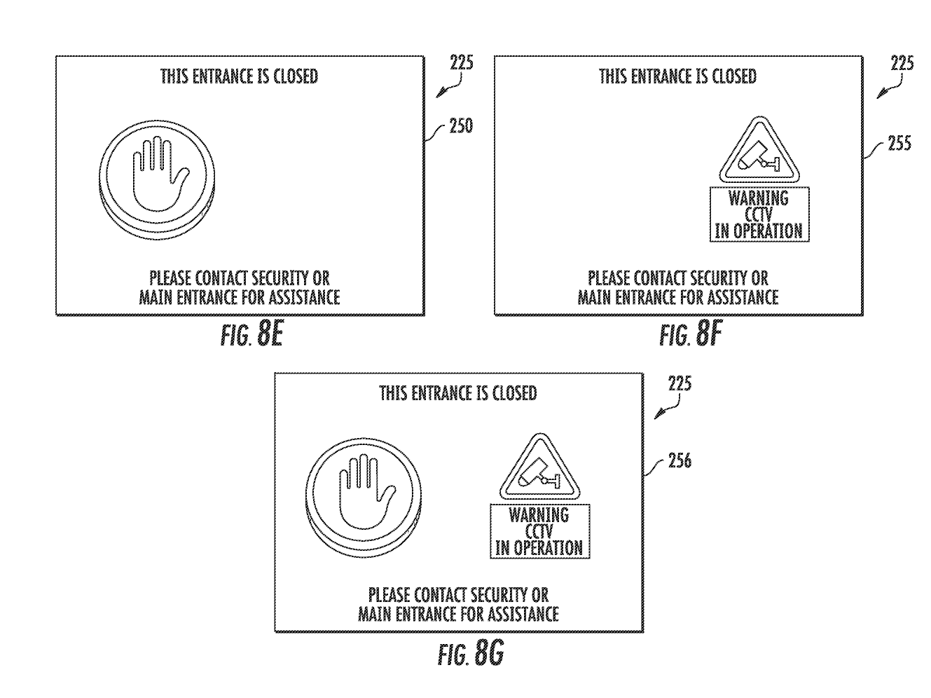

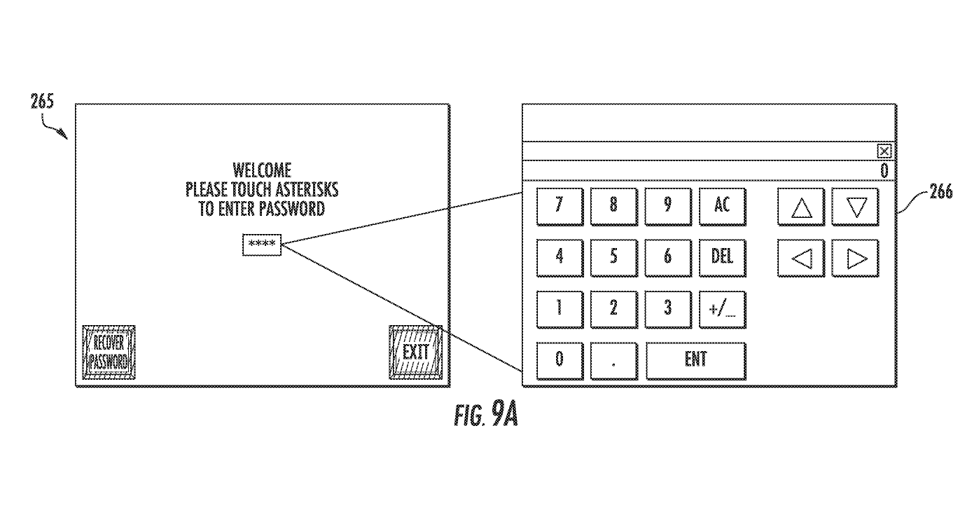

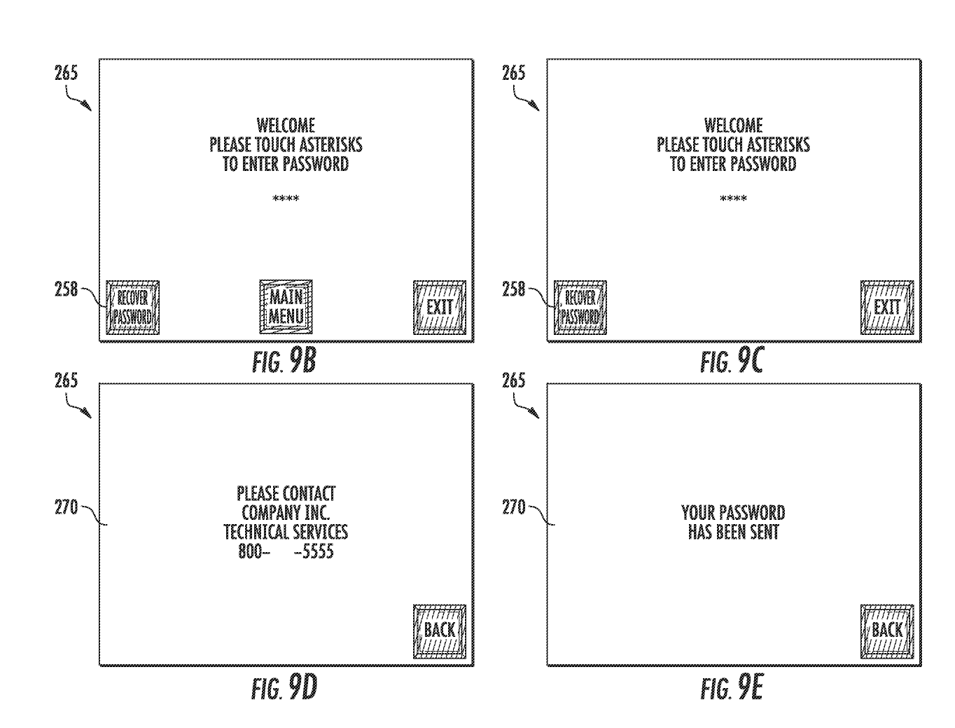

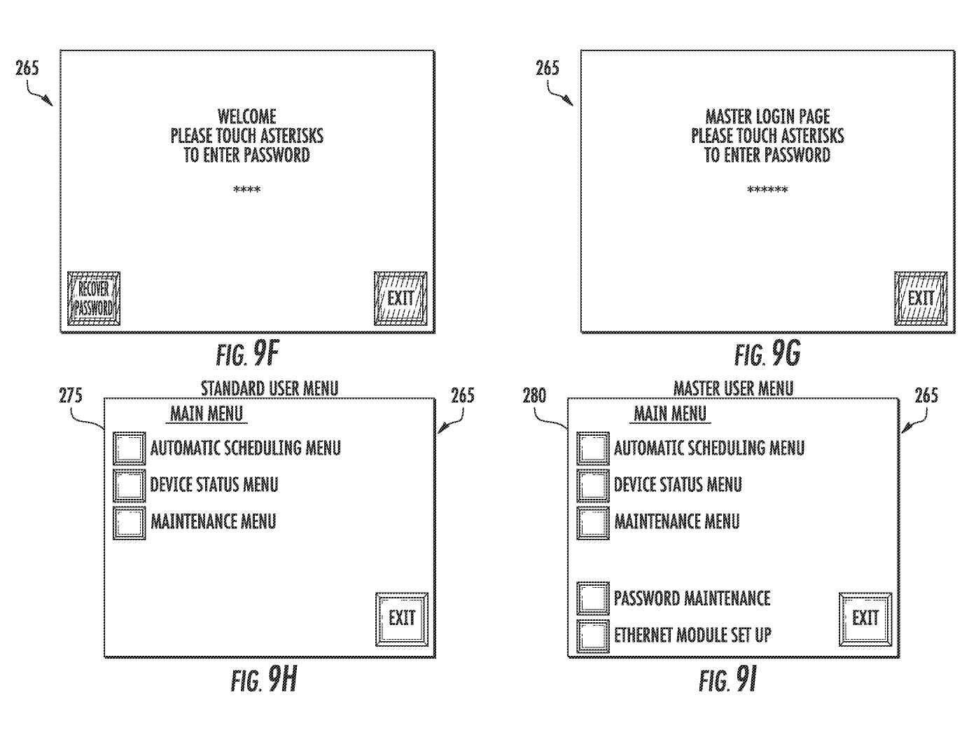

FIGS. 1A-D and FIG. 2 show an example HMI system 100 integrated with a revolving door system 105. Revolving door system 105, may include a revolving door 110, an unsecured side 113 (e.g., exterior of building), a secure side 115 (e.g., interior of building), and a main controller 130, e.g., programmable logic controller (PLC). HMI system 100 may include a secure side HMI 120 (e.g., master HMI touchscreen) and an unsecured side HMI 125 (e.g., slave HMI touchscreen). Revolving door system 105 may further include an electronic card reader (not shown). Secure side HMI 120 and unsecure side HMI 125 preferably are positioned at secure side 115 and unsecured side 113 respectively, and may include a user interface 140, such as a touchscreen. A camera 133 may also be integrated at the unsecured side 113 (and/or the secured side 115) to provide video feed to the secure side HMI 120, unsecure side HMI 125, and/or to a remote system and/or device 123 for video monitoring. There may also be a speaker (not shown) and/or microphone (not shown) integrated at the unsecured side 113 (and/or the secured side 115) to provide an audio feed to the secure side HMI 120, unsecure side HMI 125, and/or to a remote system and/or device 123 for audio communication and/or monitoring. Remote system and/or device 123 may be located on unsecured side 113 and/or on secured side 115. The HMI system 100, may also include wired and/or wireless electronic communication capability from the HMI system 100 to a remote system and/or device 123 via a communications link, for example, HMI system 100 may provide email communication via a network, e.g., via an Ethernet module that interfaces with PLC 130 of revolving door system 105.

The HMI system 100 may further include, one or more main HMI control units 135 that may be centralized (at a guard station for example), and may network multiple doors together through main HMI control unit 135 at the centralized location. Main HMI control unit 135 may also include a display and user interface 140, such as a touchscreen display, and audio and/or video capability (video camera, display, microphone, and/or speaker), for communicating with, and/or monitoring of, secure side HMI 120, unsecure side HMI 125, and/or a remote system and/or device 123. In such an embodiment, from main HMI control unit 135 a user may be able to, amongst other things, monitor video and/or audio from one or more revolving door systems 105, observe the overall status of the performance of a specific revolving door system 105, operate the HMI system 100, and/or send and/or receive electronic communications (e.g., emails) to/from respective receivers and/or other recipients. In this embodiment, there may be one or more HMI units positioned on an unsecure side 113 (e.g., unsecure side HMI 125) and/or on a secure side 115 (e.g., secure side HMI 120) of the revolving door system 105, and a main HMI control unit 135 may be positioned at a centralized location, such as a guard station.

The HMI system 100 may further includes technician/programming and pedestrian user interfacing capability through the user interface 140 of secure side HMI 120, unsecure side HMI 125, and/or main HMI control unit 135. In another embodiment HMI system 100 may include technician/programming user interfacing capability through a remote system and/or device 123 (e.g., remote computer, smartphone, tablet, pad, or other electronic device capable of electronic communication). In a preferred embodiment HMI system 100 includes secured access to the system, for example a tiered password system. In one, example, there may be two (2) or more levels of security, e.g., “Master” and “User” (Standard), that allow access to approved/restricted areas in a technician/programming interface portion of HMI system 100.

HMI system 100 preferably includes a menu driven system and software for users to electronically access and interface with HMI system 100. HMI system 100 may include various menu driven selections, accessible through, for example, user interface 140 (e.g. touchscreen display) of one or more of secure side HMI 120, unsecure side HMI 125, main HMI control unit 135, and/or a remote system and/or device 123 (e.g., remote computer, smartphone, tablet, pad, or other electronic device capable of electronic communication), which may be accessed, for example, using a security access method and/or device, such as a password/code, keycard, or the like.

In one embodiment, HMI system 100 may include a Main Menu 145 accessible by a user through user interface 140, for example, user interface 140 of main HMI control unit 135. Main Menu 145 may further include one or more of an automatic scheduling menu 150, a device status menu 155, a maintenance menu 160, a password maintenance 165 menu, a network set up menu 170, e.g., Ethernet module set up, and/or other system support type menus. Depending on level of access granted an authorized user may access all or a sub-set of the menus via user interface 140 of, for example, Main Menu 145.

In one embodiment, automatic scheduling menu 150 may be accessed from Main Menu 145 by a user via user interface 140, for example, user interface 140 of main HMI control unit 135. Automatic scheduling menu 150 may be used to electronically access and program predefined operating profiles to allow revolving door system 105 to change operating states autonomously. Automatic scheduling menu 150 preferably allows an authorized user, such as a technician, to program revolving door system 105 to various predefined profile states (e.g., free entry, free exit, locked, reporting, alarm, etc.) at requested times throughout the day and/or week. Automatic scheduling menu 150 may have sub menu screens, for example one or more security profiles screens 151, one or more daily profiles screens 152, and/or one or more date/time setting screens 153. Through automatic scheduling menu 150 and/or its associated sub menu screens a technician, for example, may program revolving door system 105 to allow revolving door 110 to rotate in only a single direction, e.g., a pedestrian can exit a building through revolving door 110, but it is locked from rotating in the counter direction to prevent a pedestrian access into the building (e.g., “free exit” on, “free in” off). The technician may program the predefined states to run at requested times throughout the day by programing, for example, the time of day that predefined profiles will be activated. In one example, the technician may program a “free exit” on/“free in” off state to be activated during a buildings off-hours. In this example, only those with authorized access to override the “free in” off state, through use of a passcode, access card, or the like, may be able to access the building during off-hours. If a technician tries to program a profile that overlaps the date/time of another programmed profile the system will indicate an error on the display of user interface 140, thus making the technician aware he/she is attempting program overlapping profiles. A technician may further be able to configure the current date and time via automatic scheduling menu 150.

Device status menu 155 may be accessed from Main Menu 145 by a user via user interface 140, for example, user interface 140 of main HMI control unit 135. Device status menu 155 allows an authorized user, such as a technician, to electronically access and monitor all device statuses and settings that interact with PLC 130 of the revolving door system 105. This provides a significant advantage over previous systems where, a technician would have been required to physically remove a portion of the door's ceiling for direct access, for example, to make electrical adjustments and/or monitor devices that interact with PLC 130. HMI system 100, allows for interfacing by the technician to be accomplished electronically at “eye level” through, for example, one or more user interfaces 140 (e.g., a touchscreen display) of main HMI control unit 135, or alternatively, via unsecure side HMI 125, secure side HMI 120, and/or a remote system or electronic device (e.g., remote computer, smartphone, tablet, pad, or other electronic device capable of electronic communication). All devices of the revolving door system 105 that interact with PLC 130 may be monitored remotely and in real-time, such as, PLC inputs/outputs, frequency drive data, camera/audio inputs and outputs, sensors, motors, and other such devices of the revolving door system 105 and HMI system 100 overall. The device status menu 155 may further allow for various system inputs to be simulated on a display of user interface 140 of main HMI control unit 135, unsecure side HMI 125, secure side HMI 120, and/or a remote system or electronic device, for example, as touch/soft buttons, for testing of the various devices. In one example, through device status menu 155 a technician may be able to view all, or a subset, of the sensors states (active, inactive, sensor error, etc.) in one or more revolving door systems 105 on a display (e.g., touchscreen) of, for example, user interface 140. Sensors within revolving door system 105 that interact with PLC 130 may be monitored for status, etc., via, for example, via one or more sensor state screens 175. Sensor state screens 175 may be one or more sub screens accessible through device status menu 155. In another example, through device status menu 155 a technician may be able to electronically view, monitor, adjust, program, upgrade, and/or test all, or a subset of, the inputs to, or outputs from, PLC 130 in one or more revolving door systems 105 electronically on a display of user interface 140. For example, a technician may issue commands to the revolving door systems 105 via user interface 140, e.g., a touchscreen display. The technician may be able to, amongst other things, simulate card reads, door locking/unlocking, reset, etc., by touching the respective buttons/icons on user interface 140. The input from devices within the revolving door systems 105 that interact with PLC 130 may also be electronically monitored for status via, for example, one or more PLC input screens 180. PLC input screens 180 may be one or more sub screens accessible through Device status menu 155. The technician may also be able to electronically monitor outputs from devices that interact with PLC 130 in one or more revolving door systems 105 on a display of user interface 140, for example, via one or more PLC output screens 185. PLC output screens 185 may be one or more sub screens accessible through Device status menu 155. Device status menu 155 may further include one or more sub screens VFD status 190, which may display and allows electronic monitoring of noted parameters of revolving door system 105. The noted parameters may include, for example, the frequency drive status of revolving door system 105, and may include, but is not limited to, output frequency, output current, and/or output voltage during various actions of revolving door system 105, e.g., forward, reverse, slow, acceleration/deceleration, etc. In one example, while revolving door 110 of revolving door system 105 is moving forward the output frequency may be about 55.00, the output current may be about 0.43, and the output voltage may be about 180.00.

Maintenance menu 160 may be accessed from Main Menu 145 by a user via user interface 140, for example, user interface 140 of main HMI control unit 135. Maintenance menu 160 preferably allows an authorized user, such as a technician, to electronically access various portions of the HMI system 100 and revolving door system 105 to allow for the technician to electronically perform, monitor, and/or investigate various entryway maintenance related data, such as service data, maintenance notifications, door rest position adjustment, event log, frequency drive settings, frequency drive setting change log, password maintenance, network settings, and/or other maintenance data. An authorized user, e.g., technician, may be able to electronically view/access service data of the HMI system 100 and revolving door system 105 via one or more service data screens 195. Service data screens 195 may be one or more sub screens of, and accessible through, maintenance menu 160. Service data screens 195 may include maintenance data, such as current date, date of last service, number of door rotations since last service, number of door rotations since new (e.g., installed), etc. Service data screens 195 may also include security data, such as number of access authorizations for each side of the revolving door (e.g., sides A and B), number of valid passages for each side of the revolving door (e.g., sides A and B), number of rejections/unauthorized attempts for each side of the revolving door (e.g., sides A and B). Service data screens 195 may also allow the authorized user, e.g., technician, to electronically reset one or more of the data values, e.g., date of service, rotations since last service, number of authorizations/ valid passages, number of rejections/unauthorized attempts, etc.

An authorized user, e.g., technician, may be able to electronically manage (e.g., view, enter, update, and/or delete) contact information via one or more automatic maintenance notification screens 200. Automatic maintenance notification screen 200 may be a sub screen of, and accessible through, maintenance menu 160. Automatic maintenance notification screen 200 may include the contact information (e.g., email address, phone/text number, pager, and/or other electronic communications contact information) that may be entered to notify the appropriate party/parties that the revolving door system 105 is due for service and/or that there is a service issue. For example, in automatic maintenance notification screen 200, the date of last service and number of rotations since last service may be viewed and/or reset and a maintenance frequency may be entered for the number of rotations before next service is to be completed, for example, when revolving door 110 reaches a certain number of rotations, e.g., 50,000, an email can be automatically sent to the appropriate party/parties, e.g., technician, that service is due.

Maintenance menu 160 may further include one or more sub screens, rest position adjustment screens 205. In the rest position adjustment screen 205, the resting position of revolving door 110 may be electronically adjusted/tuned. In previous revolving door designs, a technician would be required to remove a portion of the door's ceiling and control box cover in order to make manual adjustments to the entryway's potentiometer, for example, using various hand tools, such as a screwdriver. Through rest position adjustment screen 205 of the HMI system 100, such adjustments may be made to the rest position of revolving door 110, electronically without the technician having to disassemble the door and make adjustments manually. For example, the rest position of revolving door 110 may be adjusted “clockwise” and/or “counterclockwise” via user interface 140, for example, using touch/soft buttons, or the like, on a touchscreen display of user interface 140.

Maintenance menu 160 may further include one or more sub screens, event log screens 210. In event log screens 210, error codes of the revolving door system 105 may be electronically monitored. For example, event log screen 210 may log and allow for display error event codes and associated date, time of day, setting, and/or user ID/password. Further, contact information, such as email address, phone/text number, pager, or other electronic communications contact information, may be programmed in, and may be displayable on, the event log screen 210 to notify the appropriate party/parties that a predefined, notable event has occurred.

Maintenance menu 160 may further include one or more sub screens, frequency drive adjustment screens 215. In frequency drive adjustments screens 215, frequency drive settings including motor control parameters may be electronically modified as needed by the technician. Adjustable parameters may include, but is not limited to, normal speed/RPM's, slow speed, base voltage, base frequency, first acceleration time, first deceleration time, second acceleration time, second deceleration time, braking time, braking, and/or other applicable parameters. The adjustable parameters may be electronically adjusted via user interface 140, for example, using touch/soft buttons, or the like, on a touchscreen display of user interface 140.

Maintenance menu 160 may further include one or more sub screens, frequency drive change log screens 220. In frequency drive change log screens 220, changes to the frequency drive (e.g., VFD) may be electronically viewed and monitored. The frequency drive change log data may include code, date, time of day, setting, user ID, and/or other applicable data. This frequency drive change log data may be sent, via email or other electronic communication, to an appropriate party/parties. In one example, the frequency drive change log data is emailed via a “send” command, e.g., via a touch/soft button, or the like on a touchscreen display of user interface 140.

Main menu 145 may further include one or more sub screens, password maintenance screens 165. In password maintenance screen 165, master and user passwords may be electronically managed, e.g., added, deleted, changed, and/or maintained.

Main menu 145 may further include one or more sub screens, network settings screens 170, e.g., Ethernet module settings. The network settings screen 170 may include sub screens, for example, one or more general settings screens 171, a DNS settings screen 172, a SMTP authentication settings screen 173, and/or Email address settings screen 174, and allows a technician to electronically monitor and/or perform maintenance of, for example, door ID, main default emails and/or other electronic contact information, SMTP Server Name or IP Address, DNS Settings, SMTP Authentication, network settings, and/or the like.

User interface 140, may display a pedestrian user interface 225, for example, at unsecure side HMI 125 and/or at secure side HMI 120, which depending on the status of the door, may provide various screen images for visual output to a pedestrian. For example, pedestrian user interface 225 may include a “Welcome” screen 230 that prompts the pedestrian to present or input his/her access card, access code, or other entrance requirement, if such is required; a “Please Proceed” screen 235, or similar type message screen, prompting the pedestrian to enter, after for example, a valid access card read or access code input; a “Access Denied” screen 240, or similar type message screen, when an unauthorized access attempt is made, e.g., wrong access code or rejected access card read; a “Door Closed for Maintenance” screen 245, or similar type message screen, when the door is in maintenance mode; a “Entrance Closed” screen 250, or similar type message screen, when the door is locked; a “CCTV Activated” screen 255, or similar type message screen when the door is in a predefined secure mode and/or when an unauthorized access attempt is made; an “Door in Alarm” screen, or similar type message screen, when an alarm is detected; and/or other applicable visual outputs. Pedestrian user interface 225 may include a combination of more than one screen for visual output, for example, when a particular entryway is locked pedestrian user interface 225 may display a combined “Entrance Closed”/“CCTV Activated” screen 256. In the event of an unauthorized access attempt HMI system 100 may alert the perpetrator via pedestrian user interface 225 that they are attempting an unauthorized access and may also utilize camera 133 to capture video feed of the perpetrator, and further may send a message, or otherwise alert a security personnel via a communications line. HMI system 100 may further allow for the security personnel to see and/or communicate with the perpetrator.

Pedestrian user interface 225 may further include access to a technician interface 265 via an access button, soft key, or screen “hot spot” e.g., “hot spot” 257, on one or more of the screens of the pedestrian user interface 225, where an authorized user, e.g., technician, can use to access a technician interface 265. In one example, to gain access to technician interface 265, from pedestrian user interface 225, a technician may press and hold for a defined period of time (e.g., 5 seconds) a predefined button, soft key, icon, or region (e.g., hot spot 257) of pedestrian user interface 225. Once the technician has gained access to technician interface 265, the technician may be required to swipe an access card and/or enter an access code, or the like, via a login screen 266, or similar type screen displayed on user interface 140. Technician interface 265 may have different security levels, for example, a standard (low security level) and a master (high security level) for access by a technician based on their assigned security level, which may be linked to the technicians pass code. Technician interface 265 may allow a technician to recover his/her password via the technician interface 265, through, for example, a password recovery button 258, which accesses one or more password recovery screens 270, wherein the technician may be prompted to enter certain information to verify identity and upon verification the recovered pass code may be sent to the technician via email or by other electronic communication. Upon successful entry of the technician's password/access code the technician may select to proceed to, e.g., to the main menu, or alternatively to exit the technician interface 265. If there are differing security levels, e.g., “standard” and “master”, depending on the technician's assigned security level, which may be linked to the technician's pass code, when the technician selects main menu, either a “standard” main menu 275 will be displayed or a “master” main menu 280 will be displayed. From there the technician will be able to access (based on assigned security level) one or more of the menus and/or screens available through Main Menu 145. A technician may also be able to access technician interface 265 directly from user interface 140 of main HMI control unit 135, unsecure side HMI 125, secure side HMI 120, and/or a remote system or electronic device. From the “standard” main menu 275 or “master” main menu 280, the technician will then have access to the HMI system 100 to perform operational tasks.

It will be appreciated that various aspects of the invention may be embodied as a method, system, computer readable medium, and/or computer program product. Aspects of the invention may take the form of hardware embodiments, software embodiments (including firmware, resident software, micro-code, etc.), or embodiments combining software and hardware aspects that may all generally be referred to herein as a “circuit,” “module” or “system.” Furthermore, the methods of the invention may take the form of a computer program product on a computer-usable storage medium having computer-usable program code embodied in the medium.

Any suitable computer useable medium may be utilized for software aspects of the invention. The computer-usable or computer-readable medium may be, for example but not limited to, an electronic, magnetic, optical, electromagnetic, infrared, or semiconductor system, apparatus, device, or propagation medium. The computer readable medium may include transitory and/or non-transitory embodiments. More specific examples (a non-exhaustive list) of the computer-readable medium would include some or all of the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission medium such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Program code for carrying out operations of the invention may be written in an object oriented programming language such as Java, Smalltalk, C++ or the like. However, the program code for carrying out operations of the invention may also be written in conventional procedural programming languages, such as the “C” programming language or similar programming languages. The program code may be executed by a processor, application specific integrated circuit (ASIC), or other component that executes the program code. The program code may be simply referred to as a software application that is stored in memory (such as the computer readable medium discussed above). The program code may cause the processor (or any processor-controlled device) to produce a graphical user interface (“GUI”). The graphical user interface may be visually produced on a display device, yet the graphical user interface may also have audible features. The program code, however, may operate in any processor-controlled device, such as a computer, server, personal digital assistant, phone, television, or any processor-controlled device utilizing the processor and/or a digital signal processor.

The program code may locally and/or remotely execute. The program code, for example, may be entirely or partially stored in local memory of the processor-controlled device. The program code, however, may also be at least partially remotely stored, accessed, and downloaded to the processor-controlled device. A user's computer, for example, may entirely execute the program code or only partly execute the program code. The program code may be a stand-alone software package that is at least partly on the user's computer and/or partly executed on a remote computer or entirely on a remote computer or server. In the latter scenario, the remote computer may be connected to the user's computer through a communications network.

The invention may be applied regardless of networking environment. The communications network may be a cable network operating in the radio-frequency domain and/or the Internet Protocol (IP) domain. The communications network, however, may also include a distributed computing network, such as the Internet (sometimes alternatively known as the “World Wide Web”), an intranet, a local-area network (LAN), and/or a wide-area network (WAN). The communications network may include coaxial cables, copper wires, fiber optic lines, and/or hybrid-coaxial lines. The communications network may even include wireless portions utilizing any portion of the electromagnetic spectrum and any signaling standard (such as the IEEE 802 family of standards, GSM/CDMA/TDMA or any cellular standard, and/or the ISM band). The communications network may even include powerline portions, in which signals are communicated via electrical wiring. The invention may be applied to any wireless/wireline communications network, regardless of physical componentry, physical configuration, or communications standard(s).

Certain aspects of invention are described with reference to various methods and method steps. It will be understood that each method step can be implemented by the program code and/or by machine instructions. The program code and/or the machine instructions may create means for implementing the functions/acts specified in the methods.

The program code may also be stored in a computer-readable memory that can direct the processor, computer, or other programmable data processing apparatus to function in a particular manner, such that the program code stored in the computer-readable memory produce or transform an article of manufacture including instruction means which implement various aspects of the method steps.

The program code may also be loaded onto a computer or other programmable data processing apparatus to cause a series of operational steps to be performed to produce a processor/computer implemented process such that the program code provides steps for implementing various functions/acts specified in the methods of the invention.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, parameters, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

The foregoing detailed description of embodiments refers to the accompanying drawings, which illustrate specific embodiments of the invention. The term “the invention” or the like is used with reference to certain specific examples of the many alternative aspects or embodiments of the applicant's invention set forth in this specification, and neither its use nor its absence is intended to limit the scope of the applicant's invention or the scope of the claims. This specification is divided into sections for the convenience of the reader only. Headings should not be construed as limiting of the scope of the invention. The definitions are intended as a part of the description of the invention. It will be understood that various details of the present invention may be changed without departing from the scope of the present invention.

Furthermore, the foregoing description is for the purpose of illustration only, and not for the purpose of limitation, as the present invention is defined by the claims as set forth hereinafter.

What is claimed is:

1. An HMI (human machine interface) system integrated into an entryway system, comprising: one or more HMI units in electronic communication with a main controller of the entryway system.

2. The system of claim 1, wherein the one or more HMI units are in electronic communication with one another.

3. The system of claim 1, wherein the main controller comprises a programmable logic controller (PLC).

4. The system of claim 1, wherein the one or more HMI units comprise at least two of a master HMI unit, a slave HMI unit, and a main HMI control unit.

5. The system of claim 4, wherein the master HMI unit and main HMI control unit are capable of performing substantially the same functions.

6. The system of claim 1, wherein one or more of the one or more HMI units comprise at least one of a pedestrian user interface and a technician user interface.

7. The system of claim 6, wherein the pedestrian user interface comprises one or more of pedestrian access instructions and a status of a door of the entryway system.

8. The system of claim 6, wherein the technician user interface comprises one or more of technician access instructions and menus for operation of the HMI system.

9. The system of claim 1, wherein one of the one or more HMI units are positioned on an unsecure side of the entryway system and another of the one or more HMI units are positioned on a secured side of the entryway system.

10. The system of claim 9, wherein the HMI unit positioned on the unsecure side of the entryway system comprises a slave HMI unit and the other HMI unit positioned on the secured side of the entryway system comprises at least one of a master HMI unit and a main HMI control unit.

11. The system of claim 4, wherein the master HMI unit comprises at least a technician user interface and the slave HMI unit comprises at least a pedestrian user interface.

12. The system of claim 1, wherein the entryway system comprises a revolving door system.

13. The system of claim 1, wherein the one or more HMI units each comprise a user interface.

14. The system of claim 13, wherein the user interface comprises a touchscreen display.

15. The system of claim 1, further comprising at least one of video and audio capability.

16. The system of claim 1, wherein one of the one or more HMI units is positioned on an unsecure side of the entryway system and another of the one or more HMI units is positioned at a centralized location, wherein the HMI unit positioned at the centralized location is in electronic communication with the HMI units positioned on the unsecure side of the entryway system.

17. The system of claim 1, wherein one of the one or more HMI units are capable of electronic communication with a remote user, device, and/or system via a communications link.

18. The system of claim 17, wherein the communications link interfaces with the main controller of the entryway system.

19. The system of claim 17, wherein the main controller comprises a programmable logic controller (PLC).

20. The system of claim 19, wherein the electronic communication comprises email communication via an Ethernet module that interfaces with the PLC.

21. The system of claim 1, further comprising menu driven software for operation of the HMI system.

22. The system of claim 21, wherein operation of the HMI system comprises one or more of operation, maintenance, programming, and monitoring of the entryway system.

23. The system of claim 21, programmed to execute the menu driven software for operation of the HMI system.

24. The system of claim 21, further comprising a storage medium comprising program code embodied in the medium for executing the menu driven software for operation of the HMI system.

25. The system of claim 21, wherein the one or more HMI units and main controller are coupled to a processor, and wherein the processor executes program code embodied in a storage medium for executing the menu driven software for operation of the HMI system.
